(19) United States
(12) Patent Application Publication
(10) Pub. No.: US 2003/0189188 A1
(43) Pub. Date: Oct. 9, 2003

(54) Ammonia storage

(76) Inventors: Malcolm Timothy Frost, Kenmore Hills (AU); Raymond Louis Koenig, Fig Tree Pocket QLD (AU); Peter James Tait, Morooka QLD (AU); Gregory John Sheehan, Chapel Hill (AU)

Correspondence Address: RODMAN RODMAN, 7 SOUTH BROADWAY, WHITE PLAINS, NY, 10601

(21) Appl. No.: 10/031,215

(22) PCT Filed: Sep. 10, 2001
(86) PCT No.: PCT/AU01/01132

(30) Foreign Application Priority Data
Sep. 8, 2000 (AU) PR 0001

(51) Int. Cl. C09K 3/00

(52) U.S. Cl. 252/193

(57) ABSTRACT

Ammonia can be stored and recovered by a process which includes the steps of:

(a) absorbing ammonia into an alcohol to form an alcohol/ammonia solution;

(b) holding the alcohol/ammonia solution in a reservoir for subsequent recovery of ammonia therefrom: and

(c) heating and/or reducing the pressure of the alcohol/ammonia solution to liberate ammonia therefrom.

### TECHNICAL FIELD

The present invention relates to the storage and recovery of ammonia.

### BACKGROUND ART

Ammonia is typically stored via liquefaction or by dissolution in water. Liquefaction is energy intensive and requires storage in a pressure vessel. Storage by dissolution in water is undesirable if dry or near dry ammonia is required for subsequent use.

### SUMMARY OF THE INVENTION

In a first aspect, the present invention provides a process for storing ammonia, the process including the steps of:

(a) absorbing ammonia into an alcohol to form an alcohol/ammonia solution; and

(b) holding the alcohol/ammonia solution in a reservoir for subsequent recovery of ammonia therefrom.

In a second aspect, the present invention provides an alcohol/ammonia solution held in a reservoir for subsequent recovery of ammonia therefrom.

In a third aspect, the present invention provides a process for recovering ammonia from an alcohol/ammonia solution, the process including the step of heating and/or reducing the pressure of the alcohol/ammonia solution to liberate ammonia therefrom.

In a fourth aspect, the present invention provides a process for storing and recovering ammonia, the process including the steps of:

(a) absorbing ammonia into an alcohol to form an alcohol/ammonia solution;

(b) holding the alcohol/ammonia solution in a reservoir for subsequent recovery of ammonia therefrom; and

(c) heating and/or reducing the pressure of the alcohol/ammonia solution to liberate ammonia therefrom.

Preferably, the alcohol/ammonia solution is saturated with ammonia.

The ammonia may be absorbed into the alcohol in the reservoir.

The temperatures and pressures used for absorbing ammonia into the alcohol holding the alcohol/ammonia solution in the reservoir, and liberating ammonia from the alcohol/ammonia solution will depend upon the specific processing circumstances in which ammonia requires storage and recovery and the alcohol involved. The temperatures and pressures can be tailored to meet a variety of circumstances but it is preferred to select temperatures and pressures which minimise the capital and operating costs of equipment for storage and recovery of ammonia in accordance with the present invention.

The present invention finds particular, but not exclusive, application in processes for forming anhydrous magnesium chloride (MgCl₂) from hydrated or dehydrated solutions of MgCl₂ (“ammoniation processes”). Examples of ammoniation processes can be found in U.S. Pat. Nos. 2,381,994, 2,381,995, 3,092,450, 3,352,634, 3,966,888, 3,983,224, 4,195,070, 4,195,071, 4,201,758, 4,208,392, 4,248,838 and 5,514,359; British patent no. 2045736; and Australian patent no. 665722 which are incorporated herein by reference. Common to ammoniation processes is the ammoniation of hydrated or dehydrated solutions of MgCl₂ to form ammoniated MgCl₂ (typically MgCl₂.6NH₃) and calcination of the ammoniated MgCl₂ to form anhydrous MgCl₂. Ammonia is consumed in the ammoniation of hydrated or dehydrated solutions of MgCl₂ and is released in the calcination of ammoniated MgCl₂. The present invention facilitates storage of ammonia released during calcination in alcohols used in ammoniation processes and the release of ammonia from the resulting alcohol/ammonia solutions for use in ammoniation of hydrated or dehydrated solutions of MgCl₂.

Alcohols used in ammoniation processes (“ammoniation alcohols”) include methanol, ethanol, propanol, butanol, ethylene glycol and diethylene glycol. In some ammoniation processes, ammoniation alcohols include water and alcohols for use in the present invention include such alcohol/water solutions. Ammoniation alcohols may also include salts such as magnesium chloride, ammonium chloride and calcium chloride and alcohols for use in the present invention include such salt containing ammoniation alcohols.

Preferably, the ammonia is absorbed into the ammoniation alcohol at ambient pressure and the resulting alcohol/ammonia solution is held at ambient pressure which avoids costs associated with compression and the use of pressure vessels. However, storing ammonia under pressure falls within the scope of the of the present invention.

The temperature at which the alcohol/ammonia solution is preferably held in the reservoir will be affected by the alcohol involved and the overall flowsheet but will typically be in the range of 15-80° C., more preferably about 30-40° C. Similarly, the temperature and pressure at which ammonia is recovered will be affected by the alcohol involved and the overall flowsheet. Recovery at atmospheric pressure is desirable from a capital and operating cost perspective but recovery at reduced pressure can be desirable in some situations in view of the increased ammonia recovery. Increased temperature will favour increased ammonia recovery but preferably the temperature is not so high as to degrade the alcohol.

The ammonia may be absorbed in a series of stages, for example in a series of gas scrubbers and may be recovered in a series of stages, for example in a series of flash reactors or stripping columns which may be operated at different temperatures and pressures.

The storage of ammonia at 40° C. via liquefaction incurs an energy penalty of approximately 210 kW for the compression of the ammonia gas and approximately 500 kW in cooling per 1000 kgh⁻¹ of gaseous ammonia originally at 105 kPa and 50° C. The storage or 1000 kgh⁻¹ of ammonia originally at 105 kPa and 50° C. in glycol at 40° C. requires a cooling duty of approximately 400 kW and the storage of 1000 kgh⁻¹ of ammonia originally at 105 kPa and 50° C. in methanol at 40° C. requires a cooling duty of approximately 340 kW.

### EXAMPLES

### Example 1

Storage of Ammonia in Glycol/Glycol Salt Solutions at Various Temperatures

Into a 5-port, 1 litre round bottom flask fitted with an agitator and a thermometer was placed a known weight of ethylene glycol or a solution of glycol containing 2% w/w magnesium chloride and 2% w/w calcium chloride, known as process glycol solution. The flask was placed in a refrigerated water bath with a heater to control the temperature of the flask contents.

The flask and contents were initially brought to 40° C. The contents of the flask were then continuously sparged with ammonia gas. A condenser and receiver were also fitted to the flask to minimise glycol losses from the system. Once the heat of absorption had been dissipated by the cooling bath and the vessel contents had returned to 40° C., a liquid sample was withdrawn for assay via Kjeldahl analysis for ammonia and the change in the weight of the vessel contents was recorded to determine the amount of ammonia absorbed. For the glycol sample at 40° C. the ammonia content was 10.9% w/w and for the glycol sample containing 2% w/w calcium chloride and 2% w/w magnesium chloride, the ammonia content was 10.7% w/w. This procedure was repeated at other temperatures and the results are displayed in Table 1 and Table 2 below.

TABLE 1
Saturated Ammonia Content in Glyol
under Atmospheric Conditions

| Temperature | Ammonia Content % (w/w) |
|---|---|
| 40 | 10.9 |
| 50 | 8.7 |
| 55 | 7.3 |
| 60 | 6.2 |

TABLE 2
Saturated Ammonia Content in Glycol Containing 2% w/w
magnesium chloride and 2% w/w Calcium chloride under
Atmospheric Conditions

| Temperature | Ammonia Content % (w/w) |
|---|---|
| 40 | 10.7 |
| 60 | 6.5 |

### Example 2

Storage of Ammonia in Methanol at Various Temperatures

Into a 5-port, 1 litre round bottom flask fitted with an agitator and a thermometer was placed a known weight of methanol containing minimal water. The flask was placed in a refrigerated water bath equipped with a heater to provide temperature control. Initially, the methanol was brought to a temperature of 15° C. Ammonia gas was added at a rate of 1 litre per minute until the heat of absorption had dissipated and the contents of the vessel were returned to 15° C. under atmospheric conditions. The ammonia addition rate was maintained at 1 litre per minute for a further 30 minutes to ensure saturation and then a sample of the flask contents was taken. Care was taken not to de-gas the sample when it was withdrawn. The sample was analysed for ammonia via Kjeldahl analysis. The ammonia content was 23.61% (w/w).

The ammonia addition rate was decreased to 100 cm³ per minute and the temperature of the flask contents was gradually increased to 25° C. over a period of 30 minutes. The flask was maintained at 25° C. for a further 90 minutes to ensure equilibration of ammonia in the methanol. A sample was withdrawn and determined for ammonia content by Kjeldahl analysis. The ammonia content was 18.12% (w/w).

The temperature was similarly progressively increased to 30° C., 35° C., 40° C. and 50° C. with samples withdrawn after 90 minutes equilibration at each temperature.

The results of analysis of all samples by Kjeldahl analysis are displayed in Table 3 below.

TABLE 3
Saturated Ammonia Content in Methanol
under Atmospheric Conditions

| Temperature | Ammonia Content % (w/w) |
|---|---|
| 15 | 23.61 |
| 25 | 18.12 |
| 30 | 16.33 |
| 3S | 13.82 |
| 40 | 12.35 |
| 45 | 9.64 |
| 50 | 8.43 |

### Example 3

Storage of Ammonia in, and Recovery of Ammonia from, Glycol

Gaseous ammonia at around 140 to 150 kPa and 25 to 30° C. was sparged through the contents of a 12 m³ reaction vessel. To ensure that the contents of the reaction vessel were saturated with ammonia, ammonia was added in excess of the requirement. The excess gaseous ammonia, which also contained a fraction of inert gases and methanol, was discharged from the reactor at a rate of 100 to >500 kgh⁻¹ at a pressure slightly higher than atmospheric. The excess ammonia was then passed to a randomly packed gas scrubber possessing three equilibrium stages and operating at atmospheric pressure. Ethylene glycol containing ammonia at 3% w/w to 5% w/w, methanol at 2% w/w to 4% w/w, trace amounts of water at <0.2% w/w, and magnesium chloride at <0.1% w/w, was recirculated through the scrubber at 13 to 16 m³h⁻¹ to capture the excess ammonia. A second randomly packed scrubber also possessing three equilibrium stages was used to polish the gaseous discharge from the first scrubber. The second scrubber utilised glycol with only trace amounts of methanol and ammonia as the gas scrubbing medium. The ammonia capture efficiency of the combined scrubbers was 99.4 to 99.7%. The scrubbing glycol was maintained at 30 to 35° C. by means of two water cooled place heat exchangers to maintain high ammonia solubilities. Typically, the coolers were required to supply 55 kw of cooling duty for an excess flow from the reactor of 210 kgh⁻¹ which contained 65% w/w ammonia.

The scrubbing glycol was stored in a carbon steel tank at a temperature of 40° C. Ammonia was recovered by gradually bleeding the stored scrubbing glycol through a series of ammonia separators (heated flash reactors) which increased the temperature to 130° C. enabling the liberated ammonia to be returned to the original reaction vessel for re-use. In the first stage, the scrubbing glycol was flashed at atmospheric pressure and 130° C. and in the second stage was flashed at a moderate vacuum (28 kPaabs) and 130° C. which resulted in additional ammonia recovery. To yield 100% recovery of the excess ammonia, the strippers typically required 310 kW for the return of 137 kgh⁻¹ of ammonia.

1. A process for storing ammonia, the process including the steps of:
(a) absorbing ammonia into an alcohol to form an alcohol/ammonia solution; and
(b) holding the alcohol/ammonia solution in a reservoir for subsequent recovery of ammonia therefrom.

2. A process as claimed in claim 1 wherein the alcohol/ammonia solution is saturated with ammonia.

3. A process as claimed in claim 1 or claim 2 wherein the ammonia is absorbed into the alcohol at ambient pressure.

4. A process as claimed in any one of the preceding claims wherein the alcohol/ammonia solution is held in the reservoir at ambient pressure.

5. A process as claimed in any one of the preceding claims wherein the ammonia is absorbed into the alcohol in the reservoir.

6. A process as claimed in any one of claims 1-4 wherein the ammonia is absorbed into the alcohol in a gas scrubber.

7. A process for recovering ammonia from an alcohol/ammonia solution, the process including the step of heating and/or reducing the pressure of the alcohol/ammonia solution to liberate ammonia therefrom.

8. A process as claimed in claim 7 wherein the alcohol/ammonia solution is heated in a flash reactor or a stripping column.

9. A process for storing and recovering ammonia, the process including the steps of:
(a) absorbing ammonia into an alcohol to form an alcohol/ammonia solution;
(b) holding the alcohol/ammonia solution in a reservoir for subsequent recovery of ammonia therefrom; and
(c) heating and/or reducing the pressure of the alcohol/ammonia solution to liberate ammonia therefrom.

10. A process as claimed in any one of the preceding claims wherein the alcohol is an ammoniation alcohol or a salt containing ammoniation alcohol.

11. An alcohol/ammonia solution held in a reservoir for subsequent recovery of ammonia therefrom.

12. An alcohol/ammonia solution as claimed in claim 11 wherein the alcohol is an ammoniation alcohol or a salt containing ammoniation alcohol.
